(19) United States
(12) Patent Application Publication
(10) Pub. No.: US 2017/0174190 A1
(43) Pub. Date: Jun. 22, 2017

(54) ROLLATOR BRAKING SYSTEM

(71) Applicant: Heather Joy DeBrock, Geneseo, IL (US)

(72) Inventors: Heather Joy DeBrock, Geneseo, IL (US); Drew DeBrock, Geneseo, IL (US)

(21) Appl. No.: 15/383,586

(22) Filed: Dec. 19, 2016

Related U.S. Application Data
(60) Provisional application No. 62/268,621, filed on Dec. 17, 2015.

(51) Int. Cl. B60T 7/10; B62B 5/06; A61H 3/04; B60T 11/04

(52) U.S. Cl. CPC B60T 7/105; B60T 7/108; B60T 11/046; B62B 5/064; A61H 3/04; A61H 2003/046

(57) ABSTRACT

A rollator braking system for a rollator includes two handles, two brake lever assemblies, and two wires. The rollator includes a frame and a plurality of wheels attached to the frame for moving the rollator. The two handles are adjustably connected to the frame, and each handle including a gripping member. Each of the two brake lever assemblies include a bracket fixedly connected to the handle and a lever rotatably connected to the bracket to rotate towards and away from the gripping member when in an unlocked position, and fixedly connected to the bracket when in a locked position. Each of the two wires are operably connected between a lever assembly and a brake on one of the wheels such that when the lever is rotated towards the gripping member, the brake slows rotation of the wheel, and when the lever is in the locked position the brake stops the rotation of the wheel.

### PRIORITY

This application claims priority to and incorporates by reference in its' entirety, U.S. Provisional Patent Application No. 62/268,621, entitled “Rollator Braking System”, and filed Dec. 17, 2015.

### TECHNICAL FIELD

The present invention generally relates to rollators and more particularly to rollator braking systems.

### BACKGROUND OF THE INVENTION

For about 6 years I have listened to patients and their family members/caregivers comment on how rollator breaks are hard to operate. Patients have to remove their hands from the rollator handles and press down to secure the braking system. There is increased risk for a patient to lose their balance which could result in falling. Also, it is difficult to secure the breaks due to requiring upper body strength which the majority of the patients lack. With the new breaking system patient s have a gel handle which provides more security of hand placement versus the old handle which is plastic and does not provide as a secure hold. Patients are now able to pull up on the brakes and then push the button on the sides with any finger to secure the brakes into place. The patient no longer has to remove their hands from the handle on the breaking system which is safer for the patient. The new braking system also accommodates the patient by being able to adjust the braking button to make it easier if the patient does not have much strength to secure the brake into place.

### BRIEF DESCRIPTION OF THE DRAWINGS

FIG. 1 is a perspective view of a prior art rollator with a prior art braking system.

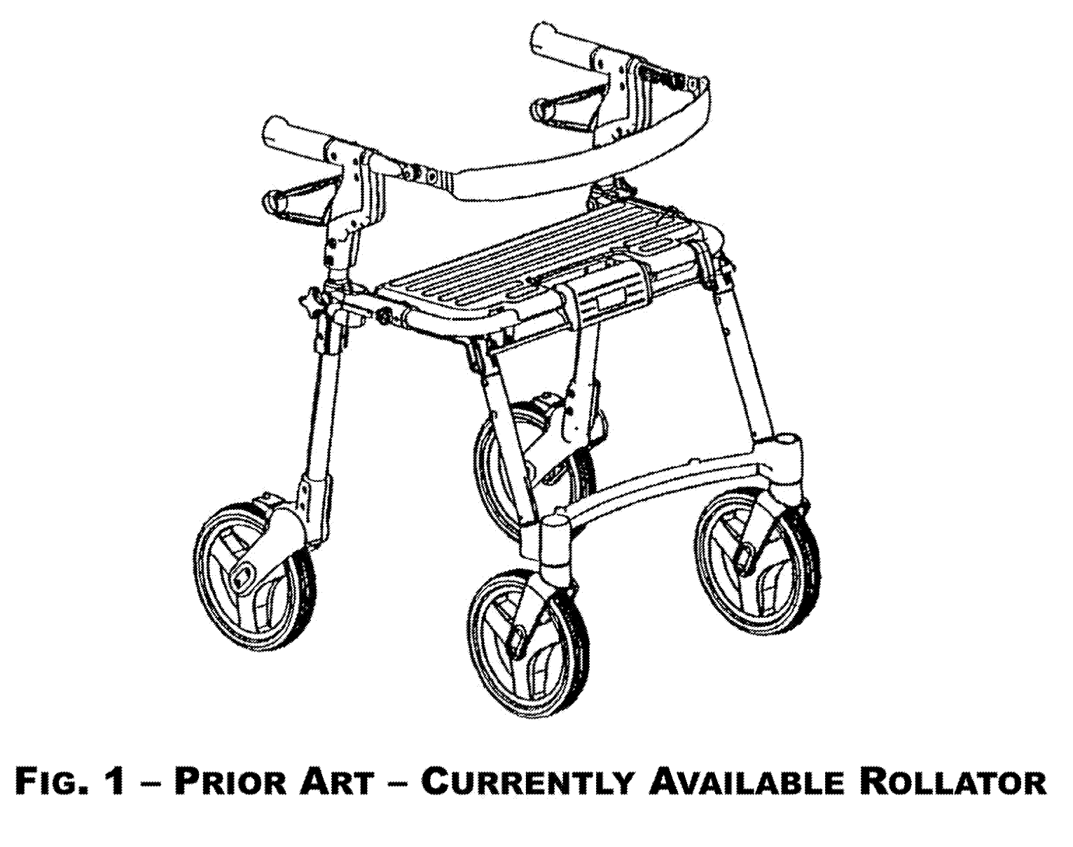

FIG. 2 is a perspective view of an exemplary rollator with the new braking system.

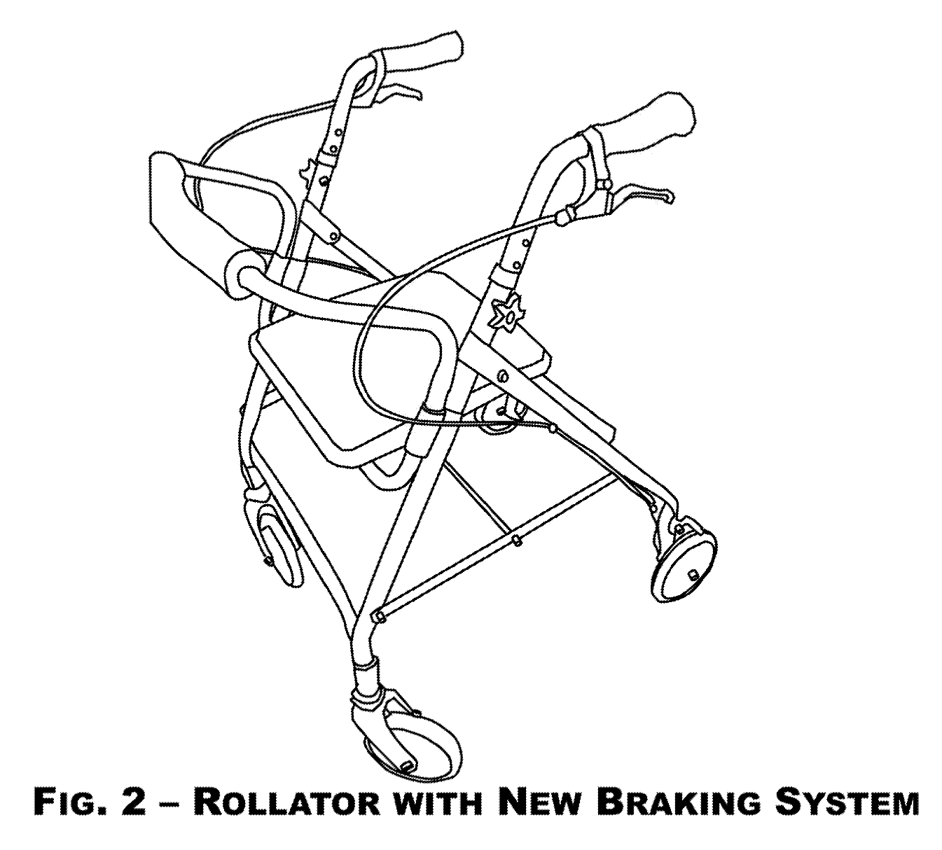

FIG. 3 is a perspective view of an exemplary embodiment of the brake lever, grip and bar of the new braking system.

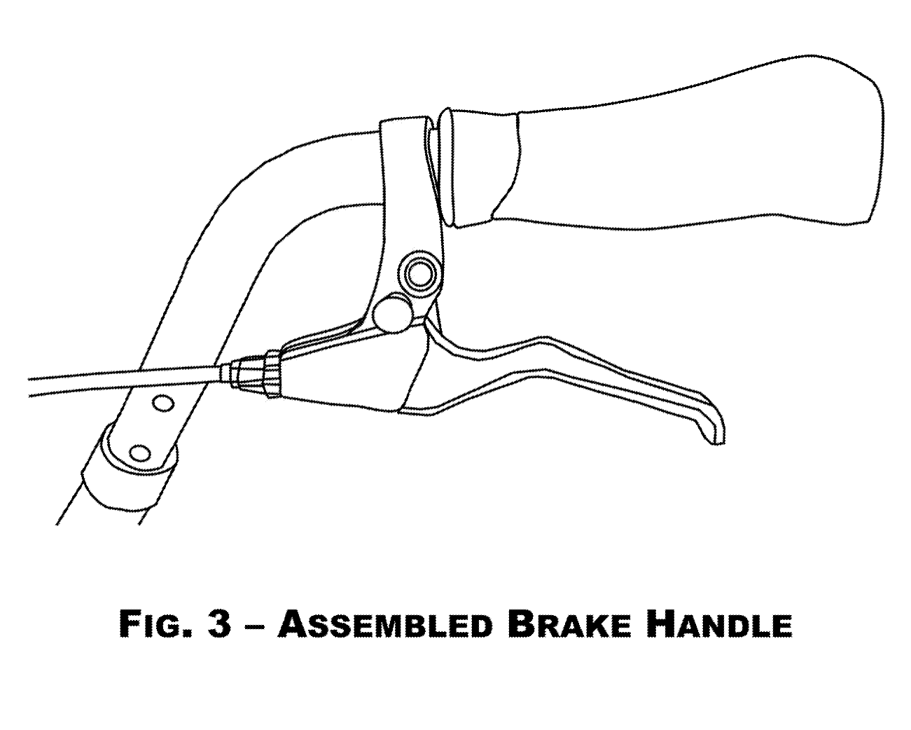

FIG. 4 is a photo of a prior art handle of a rollator with a prior art braking system.

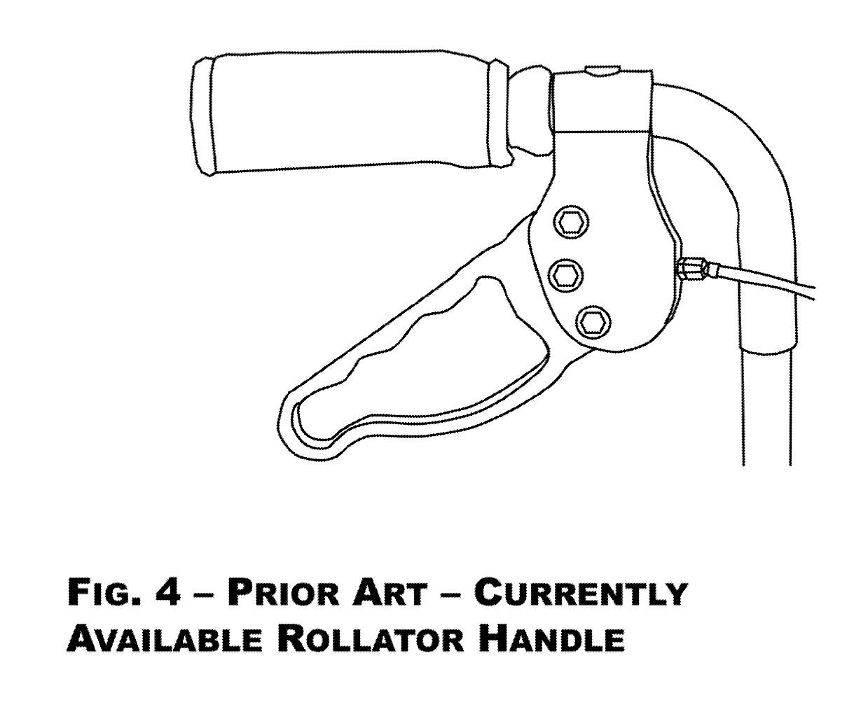

FIG. 5 is an outside perspective view of an exemplary embodiment of the brake lever of the new braking system.

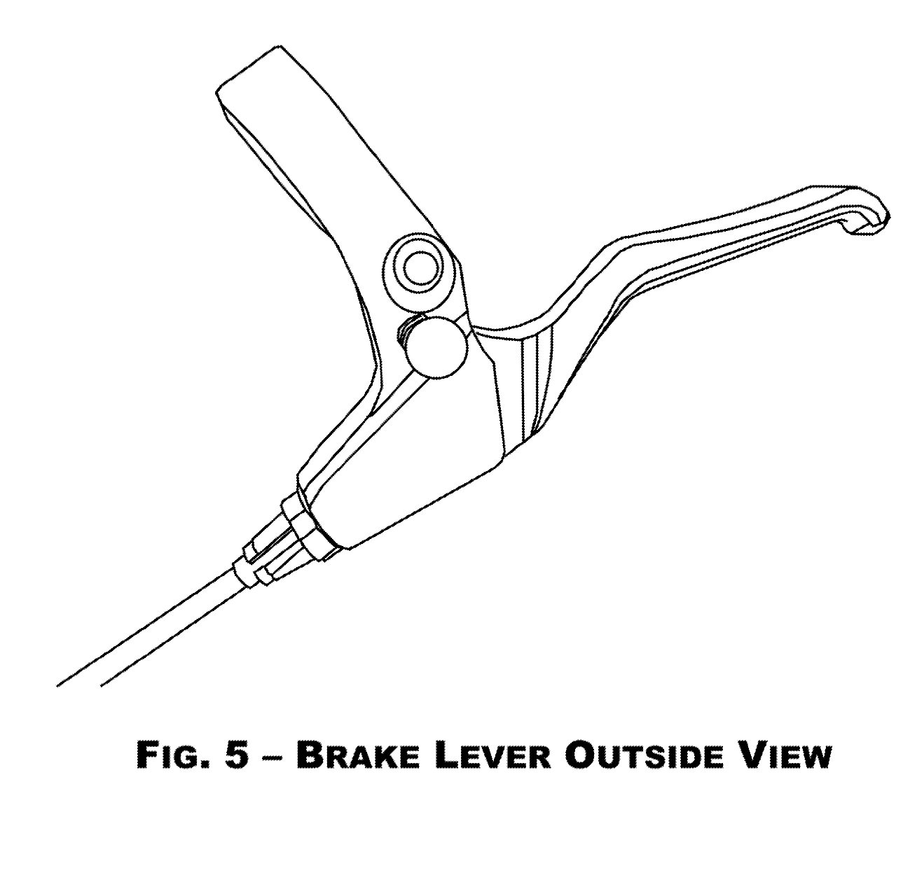

FIG. 6 is an inside perspective view of an exemplary embodiment of the brake lever of the new braking system.

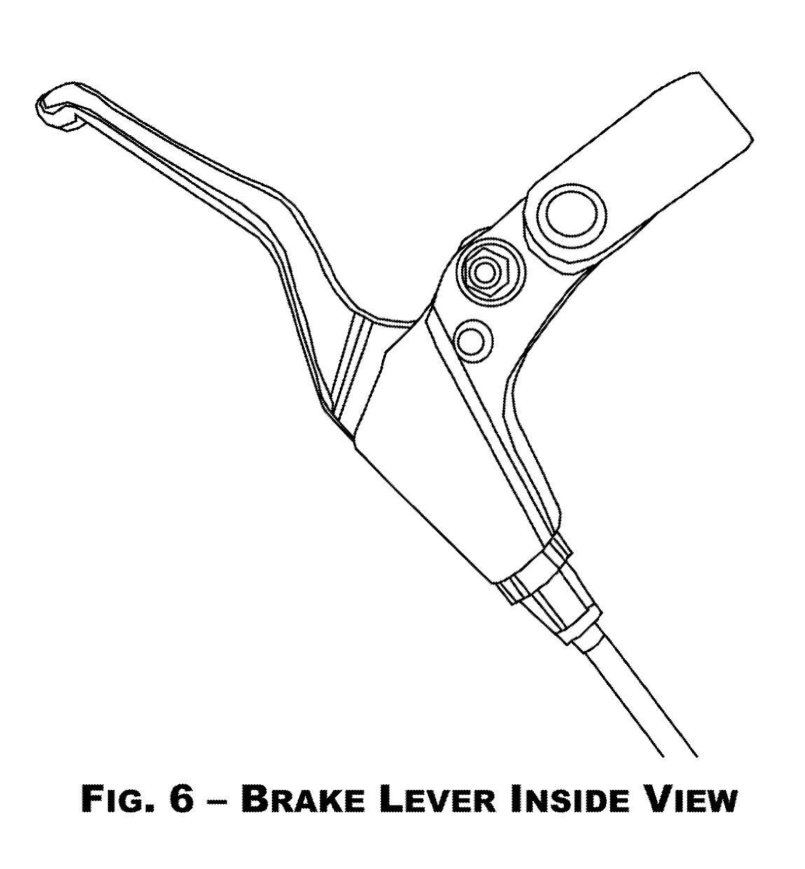

FIG. 7 is an exploded view of an exemplary embodiment of the brake lever assembly of the new braking system.

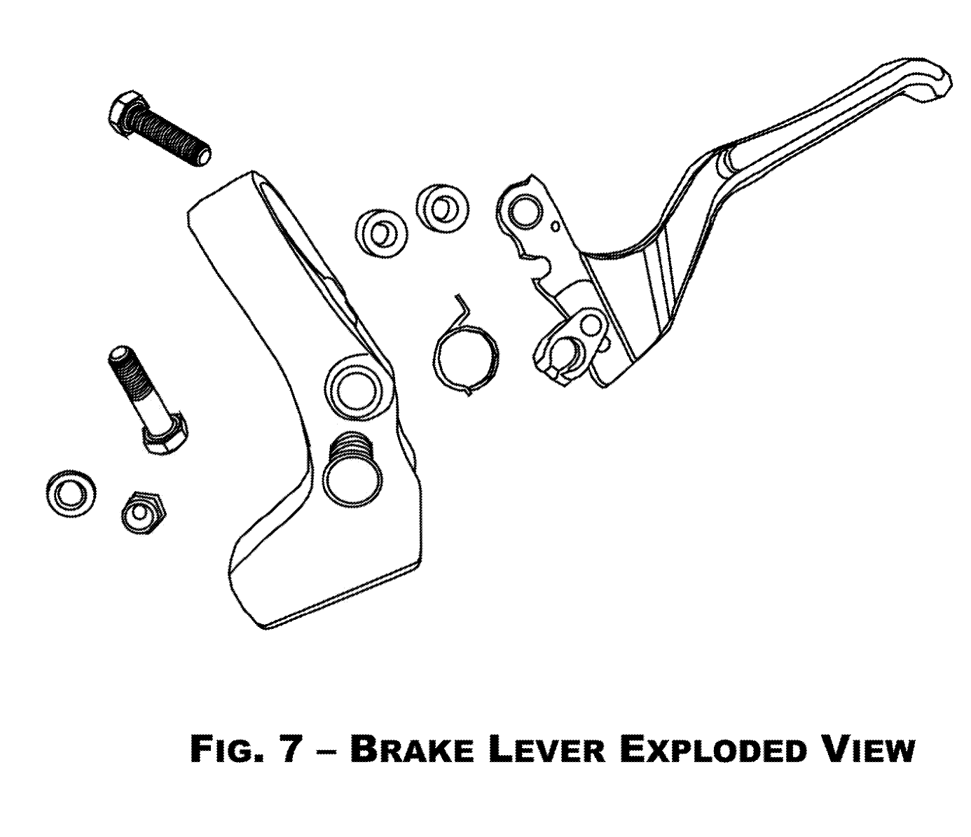

FIG. 8 is a perspective view of an exemplary embodiment of the locking mechanism of the new braking system in a disengaged position.

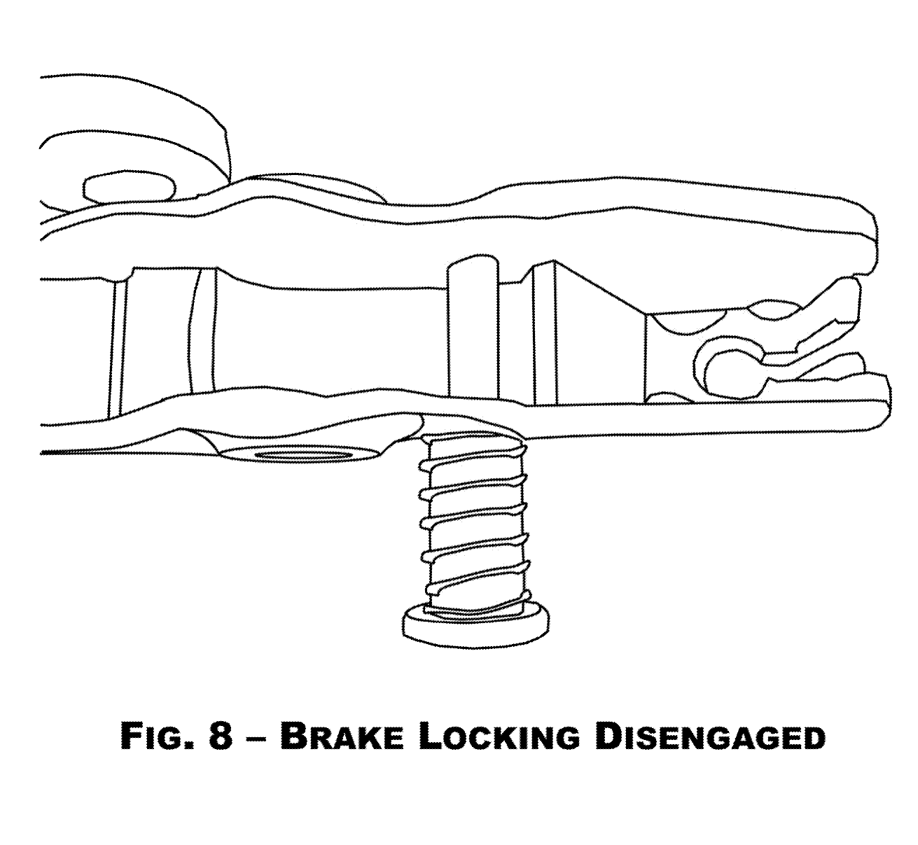

FIG. 9 is a perspective view of an exemplary embodiment of the locking mechanism of the new braking system in an engaged position.

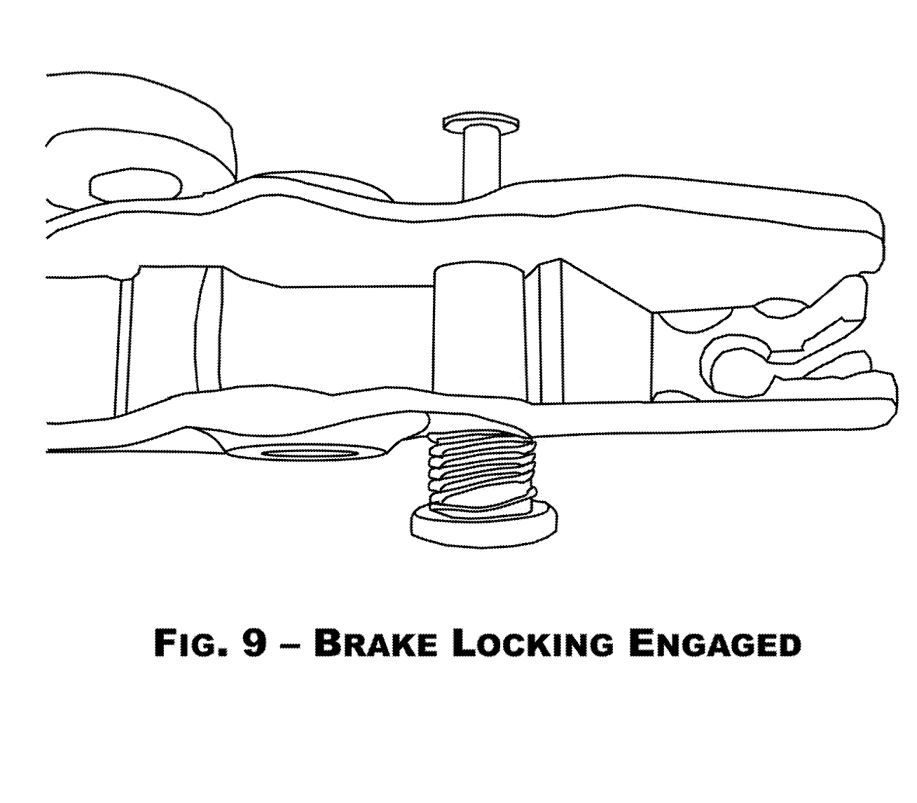

FIG. 10 is a drawing of an exemplary embodiment of the adjustable arm handle of the new braking system.

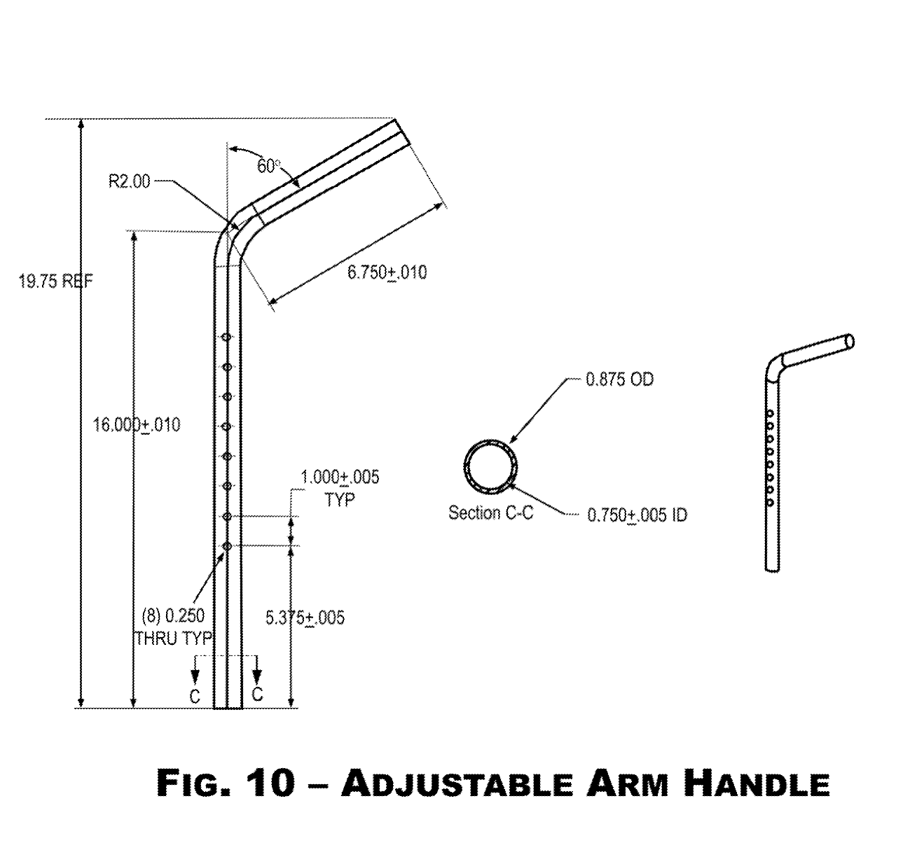

FIG. 11 is a drawing of an exemplary embodiment of the adjustable arm handle of the new braking system.

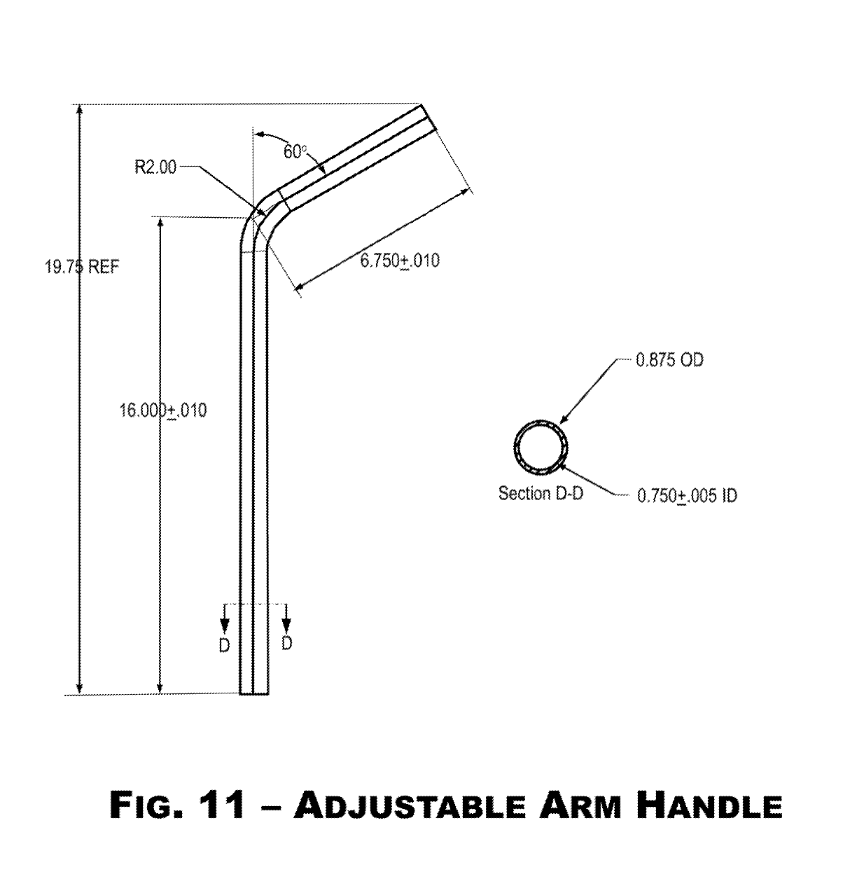

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Components:

Handle—The handle is inserted into frame of rollator and can be adjusted for proper height. The handle is held in place by a bolt with a knob that is threaded to the same as the bold. These tighten down to secure the handle into place.

Wire—The wire runs out of brake/lever down to the brakes located by the tires which will lock the wheels. This wire can be adjusted for tension on the brake.

Locking brake lever—This is the lever that when squeezed towards the grip will pull the wire that is connected to the brake down by the wheels. The brakes can also be locked by pushing the button located outside of the lever. The button is spring loaded and after it is pushed in the will stay in lock position, thus keeping the brake locked to the wheel. When wanting to release the brake so the rollator can move again, simply pull the lever towards the grip at the button that is spring loaded will pop out and release the break. The lever is attached to the handle by a ⅞″ clamp that is part of the lever. Once slide over the handle and in position, a screw is tightened and this will clamp down and tighten to the handle.

Grip—The gel grip is pushed on to the handle once the lever has been tightened into place.

Kit for Retro-Fits:

A kit including the handle, the wire, the brake lever with attaching bracket, the grip, and hardware to assemble is considered part of the invention. This kit may be used for retrofitting rollators on the market and already in use with the new braking system. The prior art handle, wire, grip, and brake lever are removed from the rollator and the new system is installed.

In one exemplary embodiment of the invention, the locking brake lever may include a Sunlite Locking Lever, model 12005. Other levers may be used in other embodiments.

It should be understood, of course, that the foregoing relates to exemplary embodiments of the invention and that modifications may be made without departing from the spirit and scope of the invention.

We claim:

1. A rollator braking system for a rollator, the rollator including a frame, and a plurality of wheels attached to the frame for moving the rollator, comprising:
two handles adjustably connected to the frame, each handle including a gripping member;
two brake lever assemblies, each brake lever assembly including a bracket fixedly connected to the handle and a lever rotatably connected to the bracket to rotate towards and away from the gripping member when in an unlocked position, and fixedly connected to the bracket when in a locked position; and
two wires, each wire operably connected between a lever assembly and a brake on one of the wheels such that when the lever is rotated towards the gripping member, the brake slows rotation of the wheel, and when the lever is in the locked position the brake stops the rotation of the wheel.
